(19) United States
(12) Patent Application Publication
(10) Pub. No.: US 2025/0127185 A1
(43) Pub. Date: Apr. 24, 2025

(54) COMPOSITIONS AND METHODS RELATED TO COCOA SUBSTITUTES DERIVED FROM SPENT COFFEE GROUNDS

(71) Applicant: Upcycled Foods, Inc., Berkeley, CA (US)

(72) Inventors: Dalton Allen, Berkeley, CA (US); Lara Ramdin, Santa Monica, CA (US)

(21) Appl. No.: 18/920,803

(22) Filed: Oct. 18, 2024

Related U.S. Application Data
(60) Provisional application No. 63/591,402, filed on Oct. 18, 2023.

(51) Int. Cl. A23G 1/34; A23F 5/08; A23F 5/16; A23F 5/46

(52) U.S. Cl. CPC A23G 1/34; A23F 5/08; A23F 5/166; A23F 5/465

(57) ABSTRACT

A method of processing used coffee grounds is provided. The method includes obtaining the used coffee grounds. The method also includes de-fatting the used coffee grounds. The method further includes flavoring the used coffee grounds. The method also includes texturizing the used coffee grounds. The method further includes aging the used coffee grounds. The method also includes grinding the used coffee grounds.

### CROSS-REFERENCE TO RELATED APPLICATIONS

This application claims priority to and the benefit of U.S. Provisional Patent Application No. 63/591,402, filed Oct. 18, 2023, which is incorporated by reference herein in its entirety.

### TECHNICAL FIELD

The present disclosure relates generally to sustainable food products and, more specifically, to spent coffee grounds as a sustainable alternative to cocoa.

### BACKGROUND OF CERTAIN ASPECTS OF THE DISCLOSURE

Coffee grounds are typically discarded after use, increasing food waste. The discarded coffee grounds are typically thrown away such that the grounds add to landfills and increase general pollution.

Accordingly, there is a need for a method of repurposing used coffee grounds for other purposes.

### BRIEF SUMMARY OF SOME ASPECTS OF THE DISCLOSURE

One aspect of the present disclosure relates to a method of processing used coffee grounds. The method includes obtaining the used coffee grounds. The method also includes de-fatting the used coffee grounds. The method further includes flavoring the used coffee grounds.

Another aspect of the present disclosure relates to method of processing used coffee grounds. The method includes obtaining the used coffee grounds. The method also includes de-fatting the used coffee grounds. The method further includes flavoring the used coffee grounds. The method also includes texturizing the used coffee grounds. The method further includes aging the used coffee grounds. The method also includes grinding the used coffee grounds.

Yet another aspect of the disclosure includes a cocoa substitute including used coffee grounds that have been defatted with a supercritical fluid and flavoring added to the used coffee grounds. The used coffee grounds simulate cocoa.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

A further understanding of the nature and advantages of the embodiments may be realized by reference to the following drawings. In the appended FIGURES, similar components or features may have the same reference label.

FIG. 1 illustrates a flow diagram of a method of processing used coffee grounds in accordance with aspects of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure relates to a novel method of utilizing upcycled spent coffee grounds as a sustainable alternative to cocoa, for example, as a substitute for cocoa powder for use in cocoa-containing food products and other compositions. The process involves the collection and defatting of coffee grounds, which are then subjected to a multi-stage process, including flavor application and vacuum-drying, which modifies the texture and flavor profile to closely resemble that of cocoa.

The disclosure showcases a sustainable approach to waste reduction and sustainability by repurposing spent coffee grounds, a largely underutilized by-product of the coffee industry, into a valuable ingredient for the food industry. The processed coffee grounds exhibit characteristics similar to cocoa, including a rich flavor profile and a fine, powdery texture, making them a suitable substitute in a wide range of products such as chocolates, baked goods, cookies beverages, and snacks.

Furthermore, this disclosure encompasses the formulation of various products utilizing the upcycled coffee grounds as a primary ingredient, offering a lower-cost and environmentally friendly alternative to traditional cocoa-based products. The method promotes circular economy principles, contributing to waste reduction and the conservation of natural resources, while providing new avenues for innovation in the food industry.

The disclosure holds the potential to revolutionize the food industry by introducing a sustainable, cost-effective, and versatile cocoa alternative, fostering innovation and sustainability in food production processes.

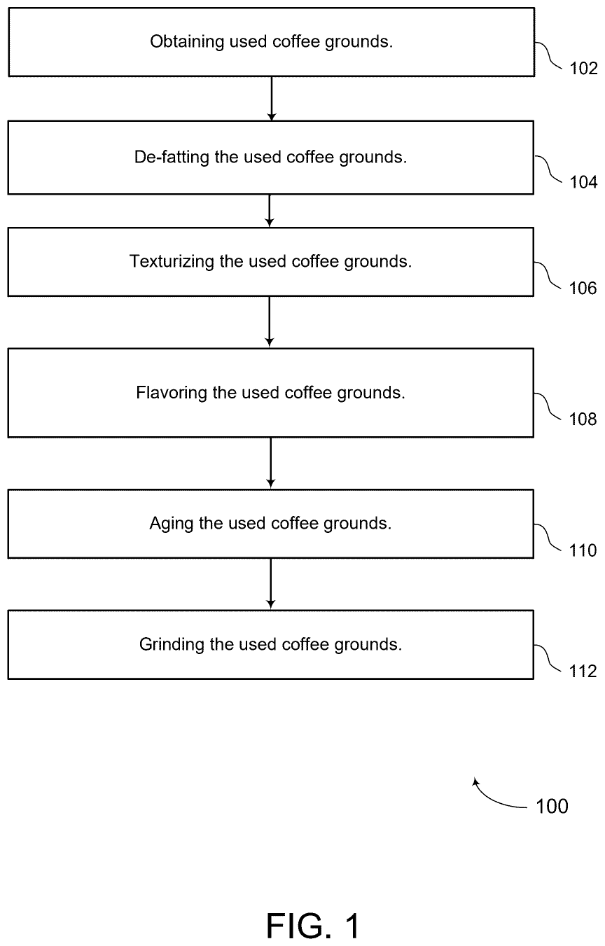

FIG. 1 illustrates a method 100 of processing used coffee grounds. The method 100 includes obtaining 102 used coffee grounds in a food safe manner. In some embodiments, obtaining 102 used coffee grounds includes obtaining used coffee grounds inline at the point of manufacture. The method 100 also includes de-fatting 104 the used coffee grounds. The method 100 further includes texturizing 106 the used coffee grounds. The method 100 also includes flavoring 108 the used coffee grounds. The method 100 further includes aging 110 the coffee grounds. The method 100 also includes grinding 112 the coffee grounds. The resulting substance mimics cocoa and is ready for use as a partial cocoa replacement.

The spent coffee grounds may be obtained, for example, from a commercial cold brew coffee manufacturing facility. The spent coffee grounds may advantageously be diverted in-line from a commercial coffee manufacturing process to inhibit contamination, for example, from bacterial and other possible contaminants.

The grounds are processed via Supercritical CO₂ extraction and pressurized screw pressing, which effectively de-fats them. De-fatting includes removing lipids and other compounds. In some embodiments, spent coffee grounds are defatted using a supercritical extraction method. Supercritical fluid extraction (SFE) is a process used to extract compounds from various substances using a supercritical fluid as the solvent. Supercritical fluids are substances that are above their critical temperature and critical pressure, meaning they are in a state that is neither fully liquid nor fully gas. Carbon dioxide (CO₂) is used as the supercritical fluid in this case because it is inexpensive, non-toxic, non-flammable, and environmentally friendly. Other similar supercritical fluids may be suitable for use within the scope of the disclosure.

In the illustrated embodiment, CO₂ is heated and pressurized to reach its supercritical state. This is done in a chamber called the pressure vessel. The supercritical CO₂ is then passed through the chamber containing the spent coffee grounds. The spent coffee grounds are passed through a double jacketed vacuum column extractor with high pressure gauge integration and a CO₂ lock cylinder with a primary regulator and stop valve.

The fluid penetrates the matrix of the material and solubilizes the compounds (lipids) to be extracted. This process can take anywhere from a few minutes to several hours.

The coffee grounds are then prepared as a medium-coarse grind (in some examples from about 250 to about 500 microns) and dried at room temperature before use.

The supercritical fluid with lipids is then passed into a lower pressure chamber where the pressure and temperature are reduced. This causes the CO₂ to revert to its gaseous state, leaving behind the extracted compounds. The pure compounds are collected, and the CO₂ gas can be recompressed and recycled back into the system.

The de-fatted substance is put into a vacuum tumbler and a variety of texture and flavor changes are affected. The remaining de-fatted coffee grounds are collected, spread out on a tray, and placed in a standard laboratory tray dryer at 30 degrees Celsius for 1 hour. Coffee grounds are then placed into an orbital mixer.

The grounds are then flavored. In one example, the grounds are exposed to a chocolate flavoring according to the following infusion process: an emulsion comprising cocoa solids, cocoa butter, theobromine, phenylethylamine (PEA), flavanols, pyrazines, esters, aldehydes (fruity and floral aroma), acetic acids, and vanillin is agitated at ambient temperature, inside of a Borosilicate glass beaker for 8 minutes on a magnetic stir plate.

Following the agitation process, the solution is added to the coffee granules in the mixing vessel, in a steady stream, via a microparticle sprayer. This microparticle sprayer is a spray system specifically designed for food applications, and allows for the chocolate flavoring solution to be evenly distributed over the defatted coffee grounds while mixing. In some versions of the method of the disclosure the spray system should provide a fine mist to ensure uniform coverage. In some such examples, the spray-on flavoring method may be performed at a 3.5 percent by weight concentration using a handheld microparticle sprayer.

Once the flavor is sprayed onto the granules evenly, the granules are placed into a vacuum tumbler for texturizing or forming the granules. The vacuum environment increases the porosity of the coffee grounds, making them more receptive to the flavoring agents. Once the vacuum is achieved, the tumbling process begins. In some methods of the disclosure, the tumbling is conducted at a low speed, and at ambient temperature to ensure that the coffee grounds are continuously mixed, allowing for an even distribution of the flavoring agent for a period of up to 1 hour. Vacuum is then released. The flavored coffee grounds are incubated at atmospheric pressure for 30 minutes and then transferred to a dryer.

In some methods of the present disclosure, the flavor infused granules are spread evenly on a tray and dried using a commercial dehydrator at 95 degrees Fahrenheit for 40 minutes. When aging is complete, the substance may then be ground to approximately 10 microns and passed through a 1250 US mesh. Grinding may be performed, for example, in a jet mill. The resulting substance mimics cocoa and is ready for use as a partial cocoa replacement.

The supercritical carbon dioxide extraction and expeller pressing with a pressurized screw may both be optimized to remove fat from the spent coffee grounds, which also removes unfavorable flavors and aromas.

The aging may be performed at an elevated temperature sufficient to degrade 3-O-caffeoyl-γ-quinide, 4-O-caffeoyl-γ-quinide, 4-O-caffeoyl-muco-γ-quinide, 5-O-caffeoyl-muco-γ-quinide, 5-O-caffeoyl-epi-8-quinide, 3-O-feruloyl-y-quinide, 4-O-feruloyl-y-quinide, 3,4-O-dicaffeoyl-γ-quinide, 4,5-O-dicaffeoyl-muco-γ-quinide, and 3,5-O-dicaffeoyl-epi-8-quinide, which may impart unfavorable flavors. Aging may also be conducted to favorably remove, for example, bitter flavors.

### Example

Coffee grounds were prepared according to the steps related above. The resulting substance was then analyzed by a third-party testing laboratory, and measurements obtained from that analysis are set forth in Table 1 below. Viable ranges for the resulting substance are also set forth in Table 1 below.

These ranges shall not limit this disclosure or any patent claim that matures from this disclosure, however, because one might either supplement a resulting substance or a precursor thereof with additional ingredients to either dilute the composition or to specifically elevate one or more components to avoid one or more ranges set forth in Table 1.

TABLE 1
Measurments of Analytes of a Cocoa Substitute and
Viable Ranges for Exemplary Cocoa Substitutes

| | | |
|---|---|---|
| Analyte | Measurement | Range |

| Water | 8.72 | percent | 4 to 18 | percent |
|---|---|---|---|---|
| Protein | 14.9 | percent | 7 to 30 | percent |
| Fat | 2.92 | percent | Less than 10 percent | |
| Fiber | 26.3 | percent | 10 to 70 | percent |
| Phosphorous | 0.10 | percent | 0.05 to 0.25 | percent |
| Potassium | 0.71 | percent | 0.3 to 1.5 | percent |
| Magnesium | 0.12 | percent | 0.05 to 0.25 | percent |
| Calcium | 0.10 | percent | 0.05 to 0.25 | percent |

| | | |
|---|---|---|
| Sodium | Less than 100 ppm | Less than 100 ppm |

| | | | | |
|---|---|---|---|---|
| Iron | 70.6 | ppm | 30 to 150 | ppm |
| Manganese | 37.0 | ppm | 15 to 75 | ppm |
| Copper | 19.1 | ppm | 10 to 40 | ppm |
| Zinc | 9.1 | ppm | 4 to 18 | ppm |

In alternative storage embodiments, flavor-infused spent coffee grounds may be stored in hermetically-sealed, flat-bottom, aluminum pouches and stored at room temperature (approx. 22 degrees Celsius).

The systems and methods disclosed herein relate to, among other things method of utilizing upcycled spent coffee grounds as a sustainable alternative to cocoa, for example, as a substitute for cocoa powder for use in cocoa-containing food products and other compositions. The process involves the collection and defatting of coffee grounds, which are then subjected to a multi-stage process, including flavor application and vacuum-drying, which modifies the texture and flavor profile to closely resemble that of cocoa.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended FIGURES, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

### Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in cither direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A method of processing used coffee grounds comprising:
obtaining the used coffee grounds;
de-fatting the used coffee grounds; and
flavoring the used coffee grounds.

2. The method of claim 1, further comprising texturizing the used coffee grounds.

3. The method of claim 1, further comprising aging the used coffee grounds.

4. The method of claim 1, further comprising grinding the used coffee grounds.

5. The method of claim 1, wherein obtaining the used coffee grounds comprises obtaining the used coffee grounds from a commercial coffee manufacturing process.

6. The method of claim 1, wherein obtaining the used coffee grounds comprises obtaining the used coffee grounds from a commercial cold brew coffee manufacturing facility.

7. The method of claim 1, wherein de-fatting the used coffee grounds comprises a supercritical extraction method.

8. The method of claim 7, wherein the supercritical extraction method comprises contacting the used coffee grounds with a supercritical fluid.

9. The method of claim 8, wherein the supercritical fluid comprises carbon dioxide.

10. The method of claim 1, wherein flavoring the used coffee grounds comprises adding a chocolate flavoring to the used coffee ground.

11. A method of processing used coffee grounds comprising:
obtaining the used coffee grounds;
de-fatting the used coffee grounds;
flavoring the used coffee grounds:
texturizing the used coffee grounds;
aging the used coffee grounds; and
grinding the used coffee grounds.

12. The method of claim 11, wherein obtaining the used coffee grounds comprises obtaining the used coffee grounds from a commercial coffee manufacturing process.

13. The method of claim 11, wherein obtaining the used coffee grounds comprises obtaining the used coffee grounds from a commercial cold brew coffee manufacturing facility.

14. The method of claim 11, wherein de-fatting the used coffee grounds comprises a supercritical extraction method.

15. The method of claim 14, wherein the supercritical extraction method comprises contacting the used coffee grounds with a supercritical fluid.

16. The method of claim 15, wherein the supercritical fluid comprises carbon dioxide.

17. The method of claim 11, wherein flavoring the used coffee grounds comprises adding a chocolate flavoring to the used coffee ground.

18. The method of claim 17, further comprising spraying the chocolate flavoring on the used coffee grounds.

19. The method of claim 11, further comprising drying the used coffee grounds.

20. A cocoa substitute comprising:
used coffee grounds that have been defatted with a supercritical fluid; and
flavoring added to the used coffee grounds, wherein the used coffee grounds simulate cocoa.
